(19) United States
(12) Patent Application Publication
(10) Pub. No.: US 2023/0219826 A1
(43) Pub. Date: Jul. 13, 2023

(54) PROCESS

(71) Applicant: EV METALS UK LIMITED, London (GB)

(72) Inventors: Daniel CAIRNS, Wilmington, DE (US); Maria RIVAS-VELAZCO, Reading (GB); Anna PALACIOS PADROS, Reading (GB)

(21) Appl. No.: 17/996,662

(22) PCT Filed: Apr. 19, 2021
(86) PCT No.: PCT/GB2021/050941

§ 371 Date: Oct. 20, 2022

(30) Foreign Application Priority Data
Apr. 20, 2020 (GB) 2005682.6

(51) Int. Cl. C01G 53/00

(52) U.S. Cl. CPC C01G 53/42; C01P 2006/80; C01P 2006/40; C01P 2004/61; C01P 2004/03

(57) ABSTRACT

A process for preparing a lithium nickel metal oxide is provided. The process comprises a step of high-energy milling a mixture of a nickel source, a lithium source and at least one additional metal source to form a high-energy milled intermediate, and subsequently calcining the high-energy milled intermediate to form the lithium nickel metal oxide.

### FIELD OF THE INVENTION

The present invention generally relates to lithium nickel metal oxide materials which have utility as cathode materials in secondary lithium-ion batteries, and to improved processes for making lithium nickel metal oxide materials.

### BACKGROUND OF THE INVENTION

Lithium nickel metal oxide materials having a layered structure find utility as cathode materials in secondary lithium-ion batteries. Typically, lithium nickel metal oxide materials are produced by mixing nickel metal precursors, such as hydroxides or oxyhydroxides, with a source of lithium, and then calcining the mixture. During the calcination process, the nickel metal precursor is lithiated and oxidised and undergoes a crystal structure transformation via intermediate phases to form the desired layered LiNiO₂ structure.

The nickel metal precursors are typically formed by co-precipitation of a mixed metal salt solution, for example a solution of one or more of nickel sulphate, cobalt sulphate, and manganese sulphate, in the presence of ammonia and sodium hydroxide at high pH.

Dopant metals are typically introduced during the co-precipitation step, or by mixing a source of dopant metal with the precipitated nickel metal precursor prior to calcination. Such precipitation processes produce significant quantities of aqueous industrial waste at high pH which may include environmentally harmful chemicals, such as trace metal salts and ammonia. Furthermore, it can be difficult to control the precipitation process which can lead to disorder in the crystalline structures of the lithium nickel metal oxide materials formed after calcination which can be detrimental to electrochemical performance.

CN102709548 (GUANGZHOU HONGSEN MATERIALS CO LTD) describes a preparation method for lithium ion battery cathode materials. In Example 1, nickel hydroxide, cobalt hydroxide, magnesium hydroxide, and lithium hydroxide are mixed in a ball mill at a speed of 30 revolutions/min for 3 hours. The mixture is then calcined at 800° C. for 16 hours.

There remains a need for improved processes for making lithium nickel metal oxide materials, and for lithium nickel metal oxide materials with improved electrochemical properties.

### SUMMARY OF THE INVENTION

The present inventors have found that high-energy milling may be used to prepare an intermediate that may be calcined to form lithium nickel metal oxide materials. The use of high-energy milling avoids the use of precipitation processes and associated issues with industrial waste. The process as described herein also offers a reduction in calcination time and temperature in comparison to prior art procedures, leading to increased process efficiency and reduced energy consumption.

Therefore, in a first aspect of the invention, there is provided a process for preparing a lithium nickel metal oxide, the process comprising the steps of:
(i) high-energy milling a mixture of a nickel source, a lithium source, and at least one additional metal source to form a high-energy milled intermediate; and
(ii) calcining the high-energy milled intermediate at a temperature of less than or equal to 750° C. to form the lithium nickel metal oxide.

Lithium nickel metal oxide materials produced by the process of the first aspect offer low levels of sulfur impurities, high levels of crystallinity, and may provide improvements in electrochemical performance, such as discharge capacity. Therefore, in a second aspect of the invention there is provided a particulate lithium nickel metal oxide material obtained or obtainable by a process according to the first aspect.

In a third aspect there is provided an electrode comprising a particulate lithium nickel metal oxide material according to the second aspect.

In a fourth aspect there is provided an electrochemical cell comprising an electrode according to the third aspect.

### BRIEF DESCRIPTION OF THE DRAWINGS

FIG. 1 shows a Scanning Electron Microscopy (SEM) image of the material produced in Example 3.

FIG. 2 shows a Scanning Electron Microscopy (SEM) image of the material produced in Example 4.

### DETAILED DESCRIPTION

Preferred and/or optional features of the invention will now be set out. Any aspect of the invention may be combined with any other aspect of the invention unless the context demands otherwise. Any of the preferred and/or optional features of any aspect may be combined, either singly or in combination, with any aspect of the invention unless the context demands otherwise.

The present invention provides a process for the preparation of lithium nickel metal oxide materials. The lithium nickel metal oxide materials are crystalline or substantially crystalline materials. They may have the α-NaFeO₂-type structure.

Typically, at least 70 atom-% of the non-lithium metal in the lithium nickel metal oxide is nickel. It may be preferred that at least 75 atom-%, at least 80 atom-%, or at least 85 atom-% of the non-lithium metal in the lithium nickel metal oxide is nickel. It may be preferred that that less than 99 atom-% of the non-lithium metal in the lithium nickel metal oxide is nickel, for example it is particularly preferred that the amount of nickel as a proportion of the non-lithium metal in the lithium nickel metal oxide is in the range of and including 70 to 99 atom-%, 75 to 99 atom-%, 80 to 99 atom-%, or 85 to 99 atom-%. The lithium nickel metal oxide comprises at least one additional metal. Typically, the metal is selected from one or more of Co, Al, V, Ti, B, Zr, Cu, Sn, Cr, Fe, Ga, Si, Zn, Mg, Sr, Mn and Ca. It may be preferred that the lithium nickel metal oxide does not contain manganese.

It may be preferred that the lithium nickel metal oxide has a composition according to Formula 1:

LiₐNiₓCo_{y}AzO_{2+b} Formula 1
in which:
A is one or more of Al, V, Ti, B, Zr, Cu, Sn, Cr, Fe, Ga, Si, Zn, Mg, Sr, Mn, and Ca;

0.8≤a≤1.2

0.7≤x<1

0≤y≤0.3

0≤z≤0.3

0.2≤b≤0.2

x+y+z=1

In Formula 1, 0.8≤a≤1.2. It may be preferred that a is greater than or equal to 0.9, or greater than or equal to 0.95. It may be preferred that a is less than or equal to 1.1, or less than or equal to 1.05. It may be preferred that 0.90≤a≤1.10, for example 0.95≤a≤1.05. It may be preferred that a=1.

In Formula I, 0.7≤x<1. It may be preferred that 0.75≤x<1, 0.8≤x<1, 0.85≤x<1 or 0.9≤x<1. It may be preferred that x is less than or equal to 0.99, 0.98, 0.97, 0.96 or 0.95. It may be preferred that 0.75≤x≤1, for example 0.75≤x≤0.99, 0.75≤x≤0.98, 0.75≤x≤0.97, 0.75≤x≤0.96 or 0.75≤x≤0.95. It may be further preferred that 0.8≤x<1, for example 0.8≤x≤0.99, 0.8≤x≤0.98, 0.8≤x≤0.97, 0.8≤x≤0.96 or 0.8≤x≤0.95. It may also be preferred that 0.85≤x<1, for example 0.85≤x≤0.99, 0.85≤x≤0.98, 0.85≤x≤0.97, 0.85≤x≤0.96 or 0.85≤x≤0.95.

In Formula 1, 0≤y≤0.3. It may be preferred that y is greater than or equal to 0.01, 0.02 or 0.03. It may be preferred that y is less than or equal to 0.2, 0.15, 0.1 or 0.05. It may also be preferred that 0.01≤y≤0.3, 0.02≤y≤0.3, 0.03≤y≤0.3, 0.01≤y≤0.25, 0.01≤y≤0.2, or 0.01≤y≤0.15.

A is one or more of Al, V, Ti, B, Zr, Cu, Sn, Cr, Fe, Ga, Si, Zn, Mg, Sr, Mn and Ca. It may be preferred that A is not Mn, and therefore that A is one or more of Al, V, Ti, B, Zr, Cu, Sn, Cr, Fe, Ga, Si, Zn, Mg, Sr, and Ca. Preferably, A is at least Mg and/or Al, or A is Al and/or Mg. More preferably, A is Mg. Where A comprises more than one element, z is the sum amount of each of the elements making up A.

In Formula I, 0≤z≤0.2. It may be preferred that 0≤z≤0.15, 0≤z≤0.10, 0≤z≤0.05, 0≤z≤0.04, 0≤z≤0.03, or 0≤z≤0.02, or that z is 0.

In Formula I, −0.2≤b≤0.2. It may be preferred that b is greater than or equal to −0.1. It may also be preferred that b is less than or equal to 0.1. It may be further preferred that −0.1≤b≤0.1, or that b is 0 or about 0.

It may be preferred that 0.8≤a≤1.2, 0.75≤x<1, 0<y≤0.25, 0≤z≤0.2, −0.2≤b≤0.2 and x+y+z=1. It may also be preferred that 0.8≤a≤1.2, 0.75≤x<1, 0<y≤0.25, 0≤z≤0.2, −0.2≤b≤0.2, x+y+z=1, M=Co, and A=Mg alone or in combination with one or more of Al, V, Ti, B, Zr, Cu, Sn, Cr, Fe, Ga, Si, Zn, Sr, Mn and Ca. It may also be preferred that 0.8≤a≤1.2, 0.75≤x<1, 0<y≤0.25, 0≤z≤0.2, −0.2≤b≤0.2, x+y+z=1, M=Co, and A=Mg alone or in combination with one or more of Al, V, Ti, B, Zr, Cu, Sn, Cr, Fe, Ga, Si, Zn, Sr, and Ca.

It may be preferred that 0.8≤a≤1.2, 0.8≤x<1, 0<y≤0.2, 0≤z≤0.2, −0.2≤b≤0.2 and x+y+z=1. It may also be preferred that 0.8≤a≤1.2, 0.8≤x<1, 0<y≤0.2, 0≤z≤0.2, −0.2≤b≤0.2, x+y+z=1, M=Co, and A=Mg alone or in combination with one or more of Al, V, Ti, B, Zr, Cu, Sn, Cr, Fe, Ga, Si, Zn, Sr, Mn and Ca. It may also be preferred that 0.8≤a≤1.2, 0.8≤x<1, 0<y≤0.2, 0≤z≤0.2, −0.2≤b≤0.2, x+y+z=1, M=Co, and A=Mg alone or in combination with one or more of Al, V, Ti, B, Zr, Cu, Sn, Cr, Fe, Ga, Si, Zn, Sr, and Ca.

It may be preferred that 0.8≤a≤1.2, 0.85≤x<1, 0<y≤0.15, 0≤z≤0.15, −0.2≤b≤0.2 and x+y+z=1. It may also be preferred that 0.8≤a≤1.2, 0.85≤x<1, 0<y≤0.15, 0≤z≤0.15, −0.2≤b≤0.2, x+y+z=1, M=Co, and A=Mg alone or in combination with one or more of Al, V, Ti, B, Zr, Cu, Sn, Cr, Fe, Ga, Si, Zn, Sr, Mn and Ca. It may also be preferred that 0.8≤a≤1.2, 0.85≤x<1, 0<y≤0.15, 0≤z≤0.15, −0.2≤b≤0.2, x+y+z=1, M=Co, and A=Mg alone or in combination with one or more of Al, V, Ti, B, Zr, Cu, Sn, Cr, Fe, Ga, Si, Zn, Sr, and Ca.

Typically, the lithium nickel metal oxide material is in the form of secondary particles which comprise a plurality of primary particles (made up from one or more crystallites). Such secondary particles typically have a D50 particle size of at least 1 μm, e.g. at least 2 μm, at least 4 μm or at least 5 μm. The particles of lithium nickel metal oxide typically have a D50 particle size of 30 μm or less, e.g. 20 μm or less, or 15 μm or less. It may be preferred that the particles of surface-modified lithium nickel metal oxide have a D50 of 1 μm to 30 μm, such as between 2 μm and 20 μm, or 5 μm and 15 μm. The term D50 as used herein refers to the median particle diameter of a volume-weighted distribution. The D50 may be determined by using a laser diffraction method (e.g. by suspending the particles in water and analysing using a Malvern Mastersizer 2000).

Advantageously, the lithium nickel metal oxide materials formed with very low levels of sulfur impurities which can be detrimental to electrochemical performance. Typically, the lithium nickel metal oxide materials have a sulfur content less than or equal to 500 ppm, such as less than or equal to 400 ppm, 300 ppm, 200 ppm or 100 ppm, for example in the range of and including 30 to 500 ppm, 30 to 400 ppm, 30 to 300 ppm, 30 to 200 ppm or 30 to 100 ppm.

Sulfur content may be measured using standard techniques, for example by pyrolysis of the material and analysis of sulfur species using infrared (IR) detection. Such analysis may be carried out using, for example, an Eltra® Helios C/S analyser. Using this technique, a sample is pyrolyzed in oxygen to oxygenate the sulphur species which are then passed through an IR cell which is used to determine the concentration of sulphur in the sample. The instrument is calibrated against a standard of a similar level or by using a multi-standard calibration.

The process comprises the step of (i) high-energy milling a mixture of a nickel source, a lithium source and at least one additional metal source to form a high-energy milled intermediate.

The term “high energy milling” is a term well understood by those skilled in the art, to distinguish from milling or grinding treatments where lower amounts of energy are delivered. For example, high energy milling may be understood to relate to milling treatments in which at least 0.1 kWh of energy is delivered during the milling treatment, per kilogram of solids being milled. For example, at least 0.15 kWh, or at least 0.20 kWh may be delivered per kilogram of solid being milled. There is no particular upper limit on the energy, but it may be less than 1.0 kWh, less than 0.90 kWh, or less than 0.80 kWh per kilogram of solids being milled. Energy in the range from 0.20 kWh/kg to 0.50 kWh/kg may be typical. The milling energy is typically sufficient to cause mechanochemical reaction of the solids being milled

High-energy milling may be carried out using a range of milling techniques that are well known to the skilled person. Suitably the high-energy milling may be carried out in a planetary mill, a vibration mill, an attritor mill, a pin mill, or a rolling mill. It may be preferred that the high energy milling step is carried out in an attritor mill. The use of an attritor mill may provide enhanced distribution of elements within the formed lithium nickel metal oxide material. Suitably, the high energy milling step is a dry milling step, i.e. no solvents are added to the mixture that is subjected to high-energy milling.

Typically, the high-energy milling step is carried out for a period of at least 15 minutes, at least 30 minutes, at least 45 minutes, or at least 60 minutes. It will be understood by the skilled person that the period is the total length of time of high-energy milling of the starting compounds, which may be the sum of two or more periods of high-energy milling. High-energy milling for a period less than 15 minutes may lead to inhomogeneous distribution of elements and/or insufficient energy input to provide an even distribution of phase transformation and lead to a requirement for longer calcination times.

Typically, the high-energy milling is carried out for a period of less than 8 hours, preferably less than 6 hours, or less than 4 hours. High-energy milling for greater than 8 hours may lead to the formation of an oxidic powder which is difficult to react during calcination to form the desired layered structure.

Typically, the high-energy milling is carried out for a period of between 15 minutes and 8 hours. Preferably, the high-energy milling is carried out for a period of between 30 minutes and 4 hours. This milling time provides a suitable balance between sufficient mechanochemical reaction of the starting compounds and process efficiency. It is preferred that mixture undergoing high-energy milling is not subjected to external heating (i.e. heating not generated by the milling process) during the high-energy milling step.

Preferably, the high-energy milling step is carried out in a CO₂-free atmosphere, such as argon, nitrogen, or a mixture of nitrogen and oxygen. As used herein, the term “CO₂-free” is intended to include atmospheres including less than 100 ppm CO₂, e.g. less than 50 ppm CO₂, less than 20 ppm CO₂ or less than 10 ppm CO₂. These CO₂ levels may be achieved by using a CO₂ scrubber to remove CO₂. The use of CO₂-free air during the milling step reduces the level of lithium carbonate in the formed lithium nickel metal oxide materials and may offer improvements in the electrochemical performance, for example enhanced discharge capacity. It may be preferred that the CO₂-free atmosphere is a mixture of nitrogen and oxygen.

Typically, high energy milling is carried out using grinding media, such as milling balls. Preferably, such media are selected to avoid metal contamination of the lithium nickel metal oxide materials formed. Preferably the milling media is formed from, or coated with, alumina or yttria-stabilised zirconia.

The mixture subjected to high-energy milling comprises at least one nickel source. Suitable nickel sources include nickel metal and nickel salts, such as inorganic nickel salts, for example nickel oxides or hydroxides. It may be preferred that the nickel source is a nickel-containing compound in which the nickel is in the +2 oxidation state. Preferably the nickel source is nickel (II) oxide (NiO) or nickel (II) hydroxide (Ni(OH)₂).

The mixture subjected to high-energy milling also comprises at least one lithium source. The lithium source comprises lithium ions and a suitable inorganic or organic counter-ion. Suitable lithium sources include lithium salts, such as inorganic lithium salts. Preferably the lithium source is lithium oxide (Li₂O) or lithium hydroxide (LiOH). More preferably, the lithium source is lithium hydroxide. The use of lithium hydroxide has been found to provide high phase purity of the formed lithium nickel metal oxide materials.

Typically, the lithium source is mixed with the nickel source and the additional metal source(s) prior to the high-energy milling step. Alternatively, or in addition, the lithium source may be added part of the way through the high energy milling process step.

The mixture subjected to high-energy milling also comprises at least one additional metal source. Suitable sources of metal include metal salts, such as inorganic metal salts. Preferably the metal salt(s) are oxides or hydroxides. More preferably, the metal salts are metal hydroxides.

Preferably, the lithium nickel metal oxide materials comprise cobalt. In such cases the mixture subjected to high-energy milling comprises at least one cobalt source, i.e. the mixture comprises a nickel source, a lithium source, a cobalt source, and optionally at least one additional metal source. Suitable cobalt sources include cobalt metal powder, or cobalt salts, such as inorganic cobalt salts, for example cobalt oxides or hydroxides. Preferably, the cobalt source is a cobalt-containing compound in which the cobalt is in the +2 oxidation state. Preferably the cobalt-containing compound is cobalt (II) oxide (CoO) or cobalt (II) hydroxide (Co(OH)₂).

Preferably, the lithium nickel metal oxide materials comprise magnesium. In such cases the mixture subjected to high-energy milling comprises at least one magnesium source, i.e. the mixture comprises a nickel source compound, a lithium source, a magnesium source, optionally a cobalt source, and optionally at least one additional metal source. Suitable magnesium sources include magnesium metal powder or magnesium salts, such as inorganic magnesium salts, for example magnesium oxides or hydroxides. Preferably the magnesium source is magnesium oxide (MgO) or magnesium hydroxide (Mg(OH)₂). In cases in which the magnesium source is MgO, it may be particularly preferred that the high energy milling is carried out in an atmosphere comprising oxygen, in particular a CO₂-free atmosphere comprising oxygen, such as a mixture of nitrogen and oxygen.

Preferably the mixture subjected to high-energy milling comprises a nickel source, a lithium source, a cobalt source and a magnesium source. Suitably the mixture comprises an oxide or hydroxide of cobalt, an oxide or hydroxide of nickel, an oxide or hydroxide of lithium, and an oxide or hydroxide or magnesium.

Preferably the mixture comprises nickel hydroxide, cobalt hydroxide, lithium hydroxide and magnesium hydroxide. The use of this combination of starting materials offers improvements in the electrochemical performance of the formed lithium nickel metal oxide materials, for example enhanced discharge capacity.

In step (ii) the high-energy-milled intermediate is then calcined to form the lithium nickel metal oxide material. The calcination step is carried out at a temperature of less than or equal to 750° C. It may be further preferred that the calcination step is carried out at a temperature less than or equal to 740° C., less than or equal to 730° C., less than or equal to 720° C., less than or equal to 710° C., or less than or equal to 700° C.

Preferably, the calcination step comprises heating the mixture to a temperature of at least about 600° C., or at least about 650° C., for example heating the mixture to a temperature of between about 600° C. and 750° C., or about 650 and 750° C. It may be further preferred that the calcination step comprises heating the mixture to a temperature of at least about 600° C., or at least about 650° C. for a period of at least 30 minutes, at least 1 hour, or at least 2 hours. The period may be less than 8 hours.

Preferably, the calcination comprises the step of heating the mixture to a temperature of 600 to 750° C. for a period of from 30 mins to 8 hours, or more preferably a temperature of 650 to 750° C. for a period of from 30 mins to 8 hours.

The calcination step may be carried out under a CO₂-free atmosphere. For example, CO₂-free air may be flowed over the materials during heating and optionally during cooling. The CO₂-free air may, for example, be a mix of oxygen and nitrogen. Preferably, the atmosphere is an oxidising atmosphere. As used herein, the term “CO₂-free” is intended to include atmospheres including less than 100 ppm CO₂, e.g. less than 50 ppm CO₂, less than 20 ppm CO₂ or less than 10 ppm CO₂. These CO₂ levels may be achieved by using a CO₂ scrubber to remove CO₂.

It may be preferred that the CO₂-free atmosphere comprises a mixture of oxygen and nitrogen. It may be further preferred that the mixture comprises nitrogen and oxygen in a ratio of from 1:99 to 90:10, for example from 1:99 to 50:50, 1:99 to 10:90, for example about 7:93.

The calcination may be carried out in any suitable furnace known to the person skilled in the art, for example a static kiln (such as a tube furnace or a muffle furnace), a tunnel furnace (in which static beds of material are moved through the furnace, such as a roller hearth kiln or push-through furnace), or a rotary furnace (including a screw-fed or auger-fed rotary furnace). The furnace used for calcination is typically capable of being operated under a controlled gas atmosphere. It may be preferred to carry out the calcination step in a furnace with a static bed of material, such as a static furnace or tunnel furnace (e.g. roller hearth kiln or push-through furnace). It is preferred that the calcination is carried out in a single furnace. This may provide benefits in process economics.

Where the calcination is carried out in a furnace with a static bed of material, the high-energy milled intermediate is typically loaded into a calcination vessel (e.g. saggar or other suitable crucible) prior to calcination.

The lithium nickel metal oxide material may be sieved after calcination. For example, the particles of lithium nickel metal oxide material may be sieved using a 50 to 60 micron sieve to remove large particles. It has been found that sieving after calcination provides significant improvements in electrochemical performance in comparison with unsieved materials, for example improvements in discharge capacity and capacity retention after cycling. For example, the particles of the lithium nickel metal oxide material may be sieved until they have a volume particle size distribution such that the D50 particle size is 25 μm or less, 20 μm or less, or 15 μm or less, for example a D50 between 5 and 25 μm, 5 and 20 μm, or 5 and 15 μm.

Alternatively, or in addition the process may include one or more milling steps, which may be carried out after calcination. The milling may be carried out until the particles reach the desired size. For example, the particles of the lithium nickel metal oxide material may be milled until they have a volume particle size distribution such that the D50 particle size is at least 5 μm, e.g. at least 5.5 μm, at least 6 μm or at least 6.5 μm. The particles of lithium nickel metal oxide material may be milled until they have a volume particle size distribution such that the D50 particle size is 25 μm or less, 20 μm or less, 15 μm or less, e.g. 14 μm or less or 13 μm or less. Preferably, the milling step(s) is not high-energy milling, i.e. that the process does not involve high-energy milling after the material has been calcined.

Optionally, a coating step is carried out on the lithium nickel metal oxide material obtained from the high temperature calcination.

The coating step may comprise contacting the lithium nickel metal oxide with a coating composition comprising one or more coating metal elements. The one or more coating metal elements may be provided as an aqueous solution. Suitably, the one or more coating elements may be provided as an aqueous solution of salts of the one or more coating metal elements, for example as nitrates or sulfates of the one or more coating metals. The one or more coating metal elements may be one or more selected from lithium, nickel, cobalt, manganese, aluminium, magnesium, zirconium, and zinc.

The coating step typically comprises the step of separating the solid from the coating composition and optionally drying the material. The separation is suitably carried out by filtration, or alternatively the separation and drying may be carried out simultaneously by spray-drying the lithium nickel metal oxide and coating solution. The coated material may be subjected to a subsequent heating step.

The process of the present invention may further comprise the step of forming an electrode (typically a cathode) comprising the lithium nickel metal oxide material. Typically, this is carried out by forming a slurry of the lithium nickel metal oxide material, applying the slurry to the surface of a current collector (e.g. an aluminium current collector), and optionally processing (e.g. calendaring) to increase the density of the electrode. The slurry may comprise one or more of a solvent, a binder, carbon material and further additives.

Typically, the electrode of the present invention will have an electrode density of at least 2.5 g/cm³, at least 2.8 g/cm³ or at least 3 g/cm³. It may have an electrode density of 4.5 g/cm³ or less, or 4 g/cm³ or less. The electrode density is the electrode density (mass/volume) of the electrode, not including the current collector the electrode is formed on. It therefore includes contributions from the active material, any additives, any additional carbon material, and any remaining binder.

The process of the present invention may further comprise constructing a battery or electrochemical cell including the electrode comprising the lithium nickel metal oxide material. The battery or cell typically further comprises an anode and an electrolyte. The battery or cell may typically be a secondary (rechargeable) lithium (e.g. lithium ion) battery.

The present invention will now be described with reference to the following examples, which are provided to assist with understanding the present invention and are not intended to limit its scope.

### EXAMPLES

### Example 1: Formation of Li_{1.03}Ni_{0.92}CO_{0.08}Mg_{0.02}O₂ Using Oxide Precursors by High Energy Milling in a Planetary Mill and Subsequent Calcination

NiO (13.57 g, Sigma Aldrich, particle size <50 nm), Co₃O₄ (1.18 g, Sigma Aldrich, particle size <50 nm)), Li₂O (6.20 g, Sigma Aldrich, 60 mesh), and MgO (0.157 g, Sigma Aldrich) (amounts selected to achieve a stoichiometric composition of Ni0.92/Co0.08/Li1.03/Mg0.02) were mixed and then transferred to 250 ml ZrO₂ milling pots. The pots were flushed with argon and tape sealed. 3 mm yttria-stabilised zirconia (YSZ) beads (200 g) were used as a grinding material. The solids were milled using a Fritsch high energy planetary mill at 400 rpm for 3×20 mins (with 10 mins of resting between milling sessions). The energy input during the high energy milling step was 0.5 kWh/kg.

The high energy milled intermediate was then calcined by heating in a CO₂-free atmosphere (nitrogen:oxygen 80:20) at a rate of 5° C./min to a temperature of 450° C., heating at 450° C. for 2 hours, heating at a rate of 2° C./min to 700° C., and then heating at 700° C. for 6 hours before cooling.

### Example 2: Formation of Li_{1.03}Ni_{0.92}CO_{0.08}Mg_{0.02}O₂ Using Mixed Hydroxide/Oxide Precursors by High Energy Milling in a Planetary Mill and Subsequent Calcination

The procedure of Example 1 was repeated using the following precursors: Ni(OH)₂ (Sigma Aldrich, 16.86 g), Co(OH)₂ (Sigma Aldrich, 1.47 g), LiOH (Sigma Aldrich, 4.97 g), and MgO (0.157 g, Sigma Aldrich).

### Example 3: Formation of Li_{1.03}Ni_{0.92}CO_{0.08}Mg_{0.02}O₂ Using Mixed Hydroxide/Oxide Precursors by High Energy Milling in an Attritor Mill and Subsequent Calcination

Ni(OH)₂ (Sigma Aldrich, 50.58 g), Co(OH)₂ (Sigma Aldrich, 4.41 g), LiOH (Sigma Aldrich, 14.91 g), and MgO (0.47 g, Sigma Aldrich) (amounts selected to achieve a stoichiometric composition of Li_{1.03}Ni_{0.92}Co_{0.08}Mg_{0.02}) were mixed and transferred to a 750 ml ZrO₂ vessel, together with 5 mm YSZ beads (400 g). The milling pot was flushed with argon and sealed before running the experiment. The solids were kept under milling conditions, 600 rpm for 60 minutes using a Union Process Laboratory HD-1 attritor mill. The energy input during the high energy milling step was 0.8 kWh/kg. The milling was conducted in a 1 bar argon atmosphere. The material was sieved after milling using a 56 micron sieve and then kept in an argon flushed pot.

The high energy milled intermediate was then calcined by heating at a rate of 5° C./min to a temperature of 450° C., heating at 450° C. for 2 hours, heating at a rate of 2° C./min to 700° C., and then heating at 700° C. for 6 hours before cooling.

### Example 4: Formation of Li_{1.03}Ni_{0.92}CO_{0.08}Mg_{0.02}O₂ Using Mixed Hydroxide/Oxide Precursors by High Energy Milling in an Attritor Mill and Subsequent Calcination

The method of Example 3 was repeated except that the milling was carried out under CO₂-free atmosphere (nitrogen:oxygen 80:20) (1 bar).

### Example 5: Formation of Li_{1.03}Ni_{0.92}CO_{0.08}Mg_{0.02}O₂ Using Hydroxide Precursors by High Energy Milling in an Attritor Mill and Subsequent Calcination

The method of Example 3 was repeated except that Mg(OH)₂ (0.69 g, Sigma Aldrich) was used instead of MgO.

### Example 6: Formation of Li_{1.03}Ni_{0.92}CO_{0.08}Mg_{0.02}O₂ Using Hydroxide Precursors by High Energy Milling in an Attritor Mill and Subsequent Calcination

The method of Example 3 was repeated except that Mg(OH)₂ (0.69 g, Sigma Aldrich) was used instead of MgO and the milling was carried out under 002-free atmosphere (nitrogen:oxygen 80:20) (1 bar).

X-Ray Diffraction (XRD) Analysis

XRD analysis of the materials formed by Examples 1-5 showed in each case the desired LiNiO₂ phase (α-NaFeO₂) as the main phase.

A comparison of the x-ray diffraction patterns of the material produced in Example 1 and Example 2 indicated a higher phase purity in the sample prepared using LiOH (Example 2) in comparison with the sample prepared with Li₂O (Example 1) which showed a Li₂O trace impurity phase was present after calcination.

High-Resolution Transmission Electron Microscopy (HRTEM)

HRTEM analysis of the materials formed in Examples 1 to 5 showed that the use of the attritor mill in Examples 3 to 5 produced a material with a higher level of magnesium distribution in comparison with samples produced by the planetary mill.

Scanning Electron Microscopy (SEM)

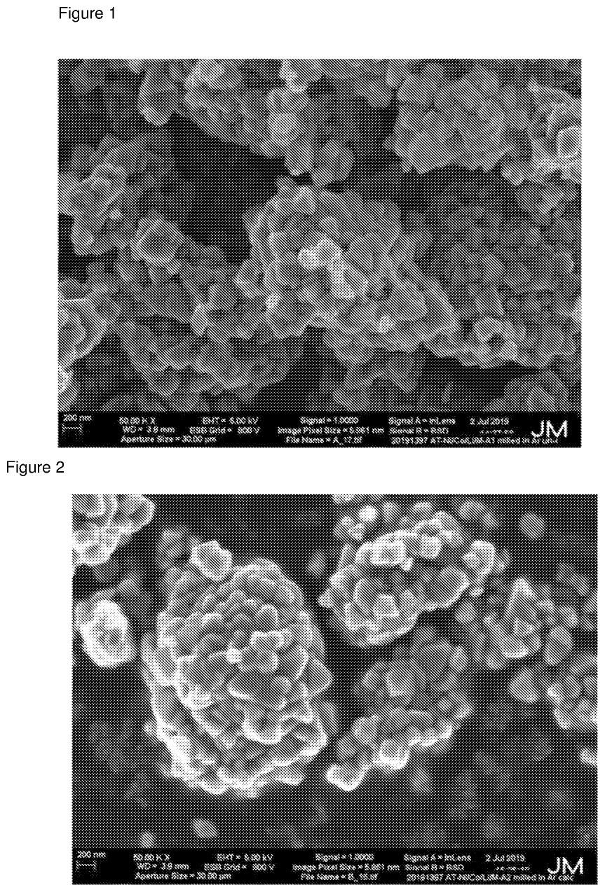

The materials produced in Example 3 (milled in Argon) and Example 4 (milled in CO₂-free air) was analysed by SEM (FIG. 1 (Example 3) and FIG. 2 (Example 4)). This indicated the particles formed were secondary particles with a spherical morphology and formed from a plurality of primary particles.

BET Surface Area

The BET surface area of the lithium nickel metal oxide materials was measured in N₂. The results are shown in Table 1 which indicated that the surface area was not significantly affected by the milling equipment or the precursors used.

TABLE 1
BET surface areas of materials produced in Examples 1 to 4

| Example | BET Surface area-N₂ (m²/g) |
|---|---|
| 1 | 1.1 |
| 2 | 1.1 |
| 3 | <2 |
| 4 | 1.1 |

Variable Temperature XRD (VT-XRD)

A sample of (i) a Ni_{0.92}Co_{0.08}Mg_{0.02}(OH)₂ precursor formed by a prior art co-precipitation process, and (ii) a sample of high energy milled intermediate prepared according to the process of Example 3, were subjected to variable temperature XRD analysis to gather information on any differences in phase changes during calcination and crystallite lattice characteristics of the products after calcination. The temperature profile used matched the calcination conditions of Example 3.

This analysis showed that the LiNiO₂ phase started to form at a lower temperature (540° C.) from the milled intermediate in comparison with the precipitated intermediate (560° C.). This indicates that the formation of an intermediate using high-energy milling offers a potential reduction in the temperature and time required for calcination in comparison with prior art method.

Reitveld analysis of the two samples at the end of the (VT-XRD) experiment showed that the lithium nickel metal oxide formed from the high-energy milled intermediate had a significantly reduced non-lithium metal occupancy of the 3a lithium site (0.17%) in comparison with the lithium nickel metal oxide formed from the precipitated intermediate (2.15%).

Electrochemical Testing

The samples from Example 3 to 6 were sieved using a 50 micron sieve and then electrochemically tested using the protocol set out below. The D50 values of the materials after sieving were Example 3: 14 μm; Example 4: 19 μm; Example 5: 21 μm. The samples were compared to (i) a sample of material from Example 4 prior to sieving and (ii) a reference sample of lithium nickel metal oxide material matching the composition of the Examples, but prepared from a commercially available Ni_{0.92}Co_{0.08}Mg_{0.02}(OH)₂ precursor (produced by precipitation) by mixing the precursor with LiOH and calcining according to the conditions described in Example 3.

Electrochemical Protocol

The electrodes were prepared by blending 94% wt of the lithium nickel metal oxide active material, 3% wt of Super-C as conductive additive and 3% wt of polyvinylidene fluoride (PVDF) as binder in N-methyl-2-pyrrolidine (NMP) as solvent. The slurry was added onto a reservoir and a 125 μm doctor blade coating (Erichsen) was applied to aluminium foil. The electrode was dried at 120° C. for 1 hour before being pressed to achieve a density of 3.0 g/cm³. Typically, loadings of active is 9 mg/cm². The pressed electrode was cut into 14 mm disks and further dried at 120° C. under vacuum for 12 hours.

Electrochemical test was performed with a CR2025 coin-cell type, which was assembled in an argon filled glove box (MBraun). Lithium foil was used as an anode. A porous polypropylene membrane (Celgrad 2400) was used as a separator. 1M LiPF₆ in 1:1:1 mixture of ethylene carbonate (EC), dimethyl carbonate (DMC) and ethyl methyl carbonate (EMC) with 1% of vinyl carbonate (VC) was used as electrolyte.

The cells were tested on a MACCOR 4000 series using C-rate and retention tests using a voltage range of between 3.0 and 4.3 V. The C-rate test charged and discharged cells at 0.1 C and 5 C (0.1 C=200 mAh/g). The capacity retention test was carried out at 1 C with samples charged and discharged over 50 cycles.

Electrochemical Results

The electrochemical results are shown in Table 2. This data shows that the performance of samples produced the process as described herein at least match the performance of the reference samples produced via a prior art precipitation route and may offer materials with increased in discharge capacity. The introduction of a sieving step after calcination significantly improves electrochemical performance such as discharge capacity retention after cycling. A comparison of Example 3 and Example 4 indicates that the use of mixed nitrogen-oxygen atmosphere during milling enhances electrochemical performance in comparison with an argon atmosphere when magnesium oxide is used as a starting material. The use of magnesium hydroxide as a magnesium source provides materials with a higher discharge capacity in comparison with materials produced from magnesium oxide.

TABLE 2
Results of electrochemical testing of lithium nickel
metal oxide materials produced in Examples 3-6.

| | | | | Discharge | | |
|---|---|---|---|---|---|---|
| | | | | capacity | | |
| | FCC | FCD | FCE | (mAh/g) | | Retention |
| Example | (mAh/g) | (mAh/g) | (%) | 0.1 C | 1 C | (%) |
| 3 | 226 | 199 | 88 | 198 | 175 | 91 |
| 4 | 236 | 208 | 88 | 209 | 189 | 92 |
| 5 | 237 | 209 | 88 | 210 | 191 | — |
| 6 | 237 | 209 | 88 | 211 | 192 | — |
| 4 (prior to | 230 | 204 | 89 | 205 | 182 | 80 |
| sieving) | | | | | | |
| Reference | 237 | 205 | 87 | 206 | 188 | 94 |

1. A process for preparing a lithium nickel metal oxide, the process comprising:
high-energy milling a mixture of a nickel source, a lithium source and at least one additional metal source to form a high-energy milled intermediate; and
(ii) calcining the high-energy milled intermediate at a temperature of less than or equal to 750° C. to form the lithium nickel metal oxide.

2. The process according to claim 1, wherein at least 70 mol-% of the non-lithium metal in the lithium nickel metal oxide is nickel.

3. The process according to claim 1, wherein the lithium nickel metal oxide has a composition according to Formula 1:
LiₐNiₓCo_{y}AzO_{2+b} Formula 1
in which:
A is one or more of Al, V, Ti, B, Zr, Cu, Sn, Cr, Fe, Ga, Si, Zn, Mg, Sr, Mn, and Ca;
0.8≤a≤1.2
0.7≤x≤1
0≤y≤0.3
0≤z≤0.3
−0.2≤b≤0.2
x+y+z=1
and wherein if y=0, z>0.

4. The process according to claim 3, wherein A is one or more of Al, V, Ti, B, Zr, Cu, Sn, Cr, Fe, Ga, Si, Zn, Mg, Sr, and Ca.

5. The process according to claim 1, wherein the high-energy milling comprises delivering from at least 0.1 kWh of energy per kilogram of solids being milled to 1.0 kWh of energy per kilogram of solids being milled.

6. The process according to claim 1, wherein the high-energy milling is carried out for a period of from 30 minutes to 4 hours.

7. The process according to claim 1, wherein the high-energy milling is carried out under a CO₂-free atmosphere.

8. The process according to claim 7, wherein the CO₂-free atmosphere is a mixture of nitrogen and oxygen.

9. The process according to claim 1, wherein the nickel source compound is nickel oxide or nickel hydroxide.

10. The process according to claim 1, wherein the lithium source is lithium oxide or lithium hydroxide.

11. The process according to claim 1, wherein A comprises Mg

12. The process according to claim 11, wherein the magnesium source is Mg(OH)₂.

13. The process according to claim 1, wherein the calcining comprises heating to a temperature of greater than about 600° C. to 750° C.

14. The process according to claim 1, wherein the calcining comprises heating to a temperature in the range of and including 600° C. and 750° C. for a period of 1 to 8 hours.

15. The process according to claim 1, further comprising sieving or milling the lithium nickel metal oxide material produced in (ii) to provide a material with a volume particle size distribution such that the D50 particle size is 25 μm or less.

16. The process according to claim 1, wherein the process further comprising coating the lithium nickel metal oxide.

17. The process according to claim 1, wherein the process further comprises forming an electrode comprising the lithium nickel metal oxide material.

18. The process according to claim 17, wherein the process further comprises constructing an electrochemical cell including the electrode comprising the lithium nickel metal oxide material.

19. A lithium nickel metal oxide compound obtained or obtainable by a process according to claim 1.

20. The lithium nickel metal oxide compound according to claim 19, the lithium nickel metal oxide having a sulfur content of less than 500 ppm.

21. An electrode, comprising a lithium nickel metal oxide compound according to claim 19.
